(19) United States
(12) Patent Application Publication
(10) Pub. No.: US 2001/0016259 A1
(43) Pub. Date: Aug. 23, 2001

(54) SIZING COMPOSITION FOR GLASS FIBERS USED TO REINFORCE THERMOPLASTIC OR THERMOSETTING MATRIX POLYMERS

(76) Inventors: LES E. CAMPBELL, ANDERSON, SC (US); ERIC L. VICKERY, WILLIAMSTON, SC (US)

Correspondence Address: OWENS CORNING, 2790 COLUMBUS ROAD, GRANVILLE, OH, 43023, US

(21) Appl. No.: 09/250,720

(22) Filed: Feb. 16, 1999

(51) Int. Cl. D02G 3/00; B32B 9/00

(52) U.S. Cl. 428/375; 428/391

(57) ABSTRACT

The present invention relates to a sizing composition for glass fibers used to reinforce thermoplastic resins, such as polyolefins, and particularly, polypropylene. The composites produced with the fiber strands coated with such sizing compositions have improved fiber adhesion and retention of fiber length. In addition, a method for improving tensile creep and tensile fatigue in polypropylene composites reinforced with glass fibers is provided.

### TECHNICAL FIELD AND INDUSTRIAL APPLICABILITY OF THE INVENTION

The present invention relates to a sizing composition for glass fibers used to reinforce thermoplastic resins, such aspolyolefins, and particularly, polypropylene. The composites produced with the fiber strands coated with such sizing compositions have improved fiber-matrix adhesion and retention of fiber length, and exhibit improved tensile creep and tensile fatigue.

### BACKGROUND OF THE INVENTION

The composite industry has been using glass fibers in various forms for reinforcing polymeric matrices, concrete, paper, paper/foil and cables to produce a variety of products. Glass fibers have been used in the form of continuous or chopped filaments, strands and rovings, as well as woven, non-woven and braided fabrics, and meshes and scrims as reinforcements.

Production of glass fibers for the composite market typically involves attenuation of the glass fibers from molten streams offiberizable glass material emanating from a bushing or like device connected to a furnace containing molterfiberizable glass material. The glass fibers are attenuated by conventional means such as winders and choppers. In the process of producing glass fibers, a chemical composition is usually applied to them shortly after they are attenuated from molten streams of glass. This chemical composition, or sizing, is typically an aqueous mixture containing one or more starches or non-starch filmformers, one or more lubricants and emulsifiers, and optionally, one or mororgano functional silanes. This chemical composition or sizing is necessary in order to retard abrasion of the glass fibers when they are gathered into glass fiber strands, as well as in subsequent processing, such as winding, twisting, weaving and braiding of the glass fibers into the final product. In addition to acting as a processing aid to prevent fiber damage from handling, the size composition is typically designed to provide the composite with improved physical properties, hydrolytic stability and corrosion resistance. After application of the sizing, the fibers are then dried either in the package form or in the chopped strand form before they are used as reinforcement.

Although numerous glass fiber sizing compositions are known, a continuing need exists for new sizing compositions that provide improved matrix resin adhesion and retention of fiber length when chopped glass fibers coated with such sizing composition are used in the reinforcement of polymeric matrices, particularly, polypropylene. This need is fulfilled by the sizing composition and process of the invention described below.

### SUMMARY OF THE INVENTION

According to this invention, an improved sizing composition is provided for treating glass fibers used to reinforce thermoplastic or thermosetting matrix polymers. The sizing compositions of the present invention are particularly well suited for use in connection with the reinforcement of polyolefin matrices, e.g., polypropylene, and provide such reinforced composites with improved tensile creep and tensile fatigue. In particular, the sizing composition provides better adhesion between the glass fiber surface and matrix resin, improved nucleation in the polypropylene at the interface region between the sizing and the matrix, and increased retention of filament length in the resulting molded parts.

According to one aspect of the invention, the sizing composition comprises: (a) a cationic high molecular weight acid or anhydride modified polypropylene film former, (b) an amino silane coupling agent, (c) a cationic lubricant, and (d) a nucleating agent. Preferably, the high molecular weight polypropylene film former has been modified by grafting maleic anhydride thereto, and has a molecular weight in excess of 35,000 Daltons, and the nucleating agent is preferably a C₁₀-C₁₈ fatty acid. The combination of these materials in the sizing composition provides improved adhesion and retention of fiber length when chopped glass fibers coated with such sizing composition are used in the reinforcement of polypropylene matrices.

Moreover, another aspect of this invention is directed to a process for improving the tensile creep and tensile fatigue exhibited by such composites under loads by increasing the adhesion between the glass fiber surface and matrix resin, nucleation in the polypropylene at the interface region between the sizing and the matrix, and retained filament length in the molded parts. The process involves reinforcing a polymeric matrix using glass fibers treated with the sizing compositions disclosed above.

### DETAILED DESCRIPTION AND PREFERRED EMBODIMENTS OF THE INVENTION

The glass fiber sizing compositions of the present invention comprise: (a) a cationic high molecular weight acid or anhydride modified polypropylene film former, (b) an amino silane coupling agent, (c) a cationic lubricant, and (d) a nucleating agent.

As used herein, the terms “size” or “sizing” refer to a composition applied to glass fibers shortly after the glass fibers are formed. The glass fibers sized in accordance with the present invention are compatible with thermoplastic matrix polymers such as polyolefin matrices and in particular, polypropylene. Polypropylene reinforced with the sized glass fibers of the present invention exhibits improved fiber adhesion and retention of fiber length, which provides composites with reduced tensile creep and fatigue under loads.

Numerous film forming polymers, including carboxylic acid or anhydride modified polyolefins, have been conventionally used in sizes for glass fibers. See, for example, U.S. Pat. Nos. 5,648,169 and 5,646,207. However, the film formers used in the present invention are cationic high molecular weight acid or anhydride modified polypropylenes that have a molecular weight greater than 35,000, and preferably, greater than 80,000 Daltons. These include emulsions of polypropylenes, mixtures of polypropylenes, or polypropylene derivatives, chemically modified to graft thereto maleic anhydride. Suitable polypropylene film formers for use in the present sizing composition include PP448 and PP353C commercially available from E.I. DuPont de Nemours; PB3001, PB3150, PB3002 commercially available from Uniroyal (Polybond Group); and G-3015 commercially available from Eastman Chemical. These polypropylenes have molecular weights ranging from approximately 35,000 to over 80,000, and maleation (maleic acid/anhydride grafting)ranging from less than 0.5 weight percent to approximately 1.8 weight percent. In a preferred embodiment, DuPont PP353C maleated polypropylene is used as the film former in the sizing compositions of the present invention. The film former of the present invention is preferably present in an amount of from about 40 percent to about 80 percent of the total dried sizing.

In addition, other conventional film formers may be present in the sizing composition in addition to the polypropylene film former. For example, polyurethane film formers may be useful in the sizing composition of the present invention. One such polyurethane film former is Aquathane 52-00-01 commercially available from Nippon Ink & Chemicals of Japan.

The aminosilane coupling agents that may be used in accordance with the present invention include any of those that are conventionally used for such purposes. For example, a mono- or di-aminated aminosilane such as gamma-aminopropyltriethoxysilane or a N-beta-(aminoethyl)-gamma-aminopropyltrimethoxysilane or any other similar aminosilane that is commercially available may conveniently be used in the present invention. For example, U.S. Pat. Nos. 5,470,658 and 5,646,207 describe suitable aminosilanes useful in sizing compositions. Preferably, gamma-aminopropyltriethoxysilane, which is commercially available from Osi Specialties, Tarrytown, N.Y. under the trade designation A-1100, is used in the present invention. The aminosilane is preferably present in an amount of from about 10 to about 20 percent of the total dried sizing.

The cationic lubricants used in the sizing compositions of the present invention reduce filament damage during the fiber forming and chopping processes. Numerous cationic lubricants are known in the art for use in sizing compositions to treat glass fibers. For example, stearic ethanolamide (Lubsize K12 commercially available from Alpha Owens Corning), or polyethyleneimine polyamides (commercially available from Henkel Inc. under the trade designations Emery 6760 and Emery 6717) can be used in the sizing compositions of the present invention. The cationic lubricant is preferably present in the sizing composition in an amount of from about 0.25 to about 1.3 percent of the total dried sizing.

The nucleating agents used in accordance with the present invention are fatty acids which provide two beneficial attributes to the sized glass fibers. First, the fatty acid provides lubricity to the glass fiber in order to minimize filament length degradation during the high shear forces of compounding and molding. Second, the fatty acid acts as a nucleating agent to affect crystalline growth of the polypropylene matrix, specifically at the interface region. In particular, the nucleating agent of the present invention is preferably a C₁₀-C₁₈ fatty acid. An example of a suitable nucleating agent is a fatty acid blend such as Moldpro 932 commercially available from Witco. The nucleating agent is preferably present in the sizing composition in an amount of from about 8.0 to about 15.0 percent of the total dried sizing.

The pH of the sizing composition is generally basic and is preferably greater than about 8.5. It may be necessary to add a pH buffer in order to maintain the pH since the cationic components present in the sizing composition may destabilize the sizing composition pH.

In addition to the above components, other components that are normally added to glass fiber sizing composition can also be present. For example, biocides, anti-foaming agents, plasticizers, humectants, antistatic agents, flame retardants, and uv light stabilizers may be used in the sizing compositions.

The glass fibers employed in the present invention can be any of the fibers known in the art for such purpose. For example, suitable fibers are typically fibers having a diameter of from about 9 to about 20 microns, and suitable strands generally contain from about 2000 to about 5000 fibers. Preferably, the fibers are in the range of from about 10 to about 17 microns and the strands formed contain from about 2400 to about 4100 fibers. The glass fibers used in the context of this invention are generally intended to reinforce thermoplastic matrices such as polyolefin matrices and, preferably, polypropylene matrices.

Shortly after being formed, the glass fibers may be treated with the sizing composition of the present invention according to methods well known in the art. The size can generally be applied with sprayers, rollers, belts, metering devices, hot melt applicators, or other similar application devices. The sized fibers are then gathered into bundles or strands comprising a plurality of individual fibers. After their formation and treatment, the strands are generally wound onto a spool or forming package and also may be chopped. The forming packages or chopped strands are usually dried either in an oven or at room temperature to remove some of the moisture from the fibers.

After application of the sizing, the size present on the fibers may be measured by determining the loss on ignition (LOI) of the rovings. The LOI refers to the reduction in weight of the fibers after heating by burning or pyrolyzing to remove the organic size from the fibers. Preferably, the sized glass fibers of the invention have an LOI of from about 0.5 percent to about 1.1 percent.

The dried fibers treated with the composition described above may be used to reinforce thermoplastic matrix polymers such as polyolefins and, particularly, polypropylene, in any of the molding processes known to those skilled in the art utilizing either chopped strand, continuous strand, or a mixture thereof. Preferably, the molding process uses chopped fiber strands mixed or compounded with matrix polymer pellets, e.g., polypropylene, to produce a homogeneous batch of molding compound. The batch can then be used, for example, in compression or injection molding to produce the fiber reinforced polymeric part or shaped device.

In another embodiment of the invention, this invention relates to a process of improving the tensile creep and tensile fatigue of such molded parts under loads. This is accomplished by increasing the adhesion between the glass fiber surface and matrix resin, nucleation in the polypropylene at the interface region between the sizing and the matrix, and retained filament length in the molded parts. The process involves reinforcing a polymeric matrix with glass fibers treated with the sizing compositions disclosed above.

In order that the invention may be more readily understood, reference is made to the following examples, which are intended to be illustrative of the invention, but are not intended to be limiting in scope.

### EXAMPLE I

This example illustrates the preparation of preferred sizing compositions for glass fibers according to the present invention. In Table 1, there are shown various sizing compositions of the invention, samples 1-6, for treating glass fibers.

TABLE 1

| SAMPLE | | 1 | | 2 | | 3 |
|---|---|---|---|---|---|---|
| Ingredients | % | Amount in grams | % | Amount in grams | % | Amount in grams |
| A1100¹ (silane) | 1.5 | 150 | 1.5 | 150 | 1.5 | 150 |
| Moldpro 932² | 3.0 | 300 | 3.0 | 300 | 3.0 | 300 |
| PP448C³ | 11.0 | 1100 | 11.0 | 1100 | 11.0 | 1100 |
| Aquathane 52-00-01⁴ | 0.5 | 50 | 0.5 | 50 | 0.5 | 50 |
| K-12⁵ (8.8%) | 0.08 | 8 | 0.24 | 24 | — | — |
| 6760T⁶ (50%) | — | — | — | — | 0.01 | 1 |
| Strand solids | | 0.64 | | 0.57 | | 0.58 |
| WATER | 83.92 | 8,021 | 83.76 | 7,957 | 83.99 | 8,819 |
| Quantity | | 9,558 | | 9,500 | | 10,500 |
| SAMPLE | | 4 | | 5 | | 6 |
| Ingredients | % | Amount in grams | % | Amount in grams | % | Amount in grams |
| A1100¹ (silane) | 1.5 | 150 | 1.5 | 150 | 1.5 | 150 |
| Moldpro 932¹ | 3.0 | 300 | 3.0 | 300 | 3.0 | 300 |
| PP448C¹ | 12.0 | 1200 | 12.0 | 1200 | 12.0 | 1200 |
| Aquathane 52-00-01 | 0.5 | 50 | 0.5 | 50 | 0.5 | 50 |
| K-12¹ (8.8%) | 0.08 | 8 | 0.24 | 24 | — | — |
| 6760T¹ (50%) | — | — | — | — | 0.01 | 1 |
| Strand solids | | 0.97 | | 1.07 | | — |
| WATER | 82.92 | 7,877 | 82.76 | 8,251 | 82.99 | 7,884 |
| Quantity | | 9,500 | | 9,970 | | 9,500 |

¹A1100 is a gamma-aminopropyltriethoxysilane obtained from Osi Specialties, Tarrytown, N.Y.
²Moldpro 932 is a fatty acid nucleating agent obtained from Whitco.
³PP448C is a high molecular weight maleonated polypropylene obtained from E.I. DuPont de Nemours.
⁴Aquathane 52-00-01 is a polyurethane film former obtained from Nippon Ink & Chemicals of Japan.
⁵Lubsize K-12 is a cationic lubricant commercially available from Alpha Owens Corning.
⁶6760 T is a polyethylene polyamide salt cationic lubricant obtained from Henkel, Inc.

The sizing composition of samples 1-6 were formulated in the following manner. A premix of the polypropylene dispersed in water was first made. To this premix, is added the fatty acid emulsion and the polyurethane dispersion under agitation. A separate premix of the organosilane in water was prepared and added to the former premix. Finally, additional deionized water was added to attain the desired solids content.

Glass fibers having a diameter of 13.7 microns were treated with the sizing compositions 1-6 and chopped into lengths suitable for use as a reinforcement media in molded parts. Test specimens were prepared by compounding the sized fiber segments with a polypropylene resin, comprising 5% by weight PB3002 maleated polypropylene and 95% by weight Montel 6523 homopolypropylene resin, in a 2½ inch single screw HPM extruder, and injection molding the resulting compound into plaques in a 150 ton Cincinnati Molding Machine. The physical properties of the resulting plaques were determined according to the procedures set forth in ASTM D638 (tensile strength); ASTM D256-81 (flexural strength); and ASTM D790 (IZOD impact strength). The mechanical properties of the composites reinforced with these treated fibers are set forth in Table 2.

TABLE 2

| | | | UNNOTCHED | |
|---|---|---|---|---|
| | TENSILE | | IZOD IMPACT | GLASS |
| | STRENGTH | FLEXURAL | STRENGTH | CONTENT |
| SAMPLE | (psi) | STRENGTH | (ft-lb/in) | WEIGHT % |
| 1 | 12,102 | | 12.193 | 30.4 |
| 2 | 12,453 | | 13.57 | 30.5 |
| 3 | 12.696 | excellent | 13.14 | 30.2 |
| 4 | 12,678 | excellent | 13.544 | 29.9 |
| 5 | 12,701 | excellent | 13.325 | 29.7 |
| 6 | 12,773 | excellent | 13.605 | 29.6 |

Applicants observed very good tensile and impact strengths. In particular, the addition of K-12 and 6760T (both cationic lubricants) in combination with the fatty acid nucleating agents and high molecular weight maleonated polypropylene was very beneficial in minimizing filament damage during the chopping process. It was expected that good creep and fatigue properties could be correlated with this data as determined by measuring retained filament length in the resulting molded parts.

### EXAMPLE II

In order to determine how to stabilize the Moldpro 932 emulsion upon the addition of A1100 to the polypropylene emulsion mixture, the following experiments were performed. Deionized water having a pH of 7.3 was added to A1100 premix having a pH of 10.7. The pH of the A1100 solution was then adjusted according to Table 3 prior to adding the polypropylene emulsion. Then about 3 percent by weight Moldpro 932 emulsion having a pH of 4.5-5.0 was added to the main mix tank. The resulting level of precipitation of the Moldpro 932 is shown below in Table 3.

TABLE 3

| A1100 pH prior to PP | |
|---|---|
| emulsion addition | Results |
| 10.7 | Moldpro 932 dispersion; heavy precipitation |
| 6.7 (acetic acid adjusted) | Moldpro 932 dispersion; precipitates, |
| | but not as much |
| 5.5 (acetic acid adjusted) | slight precipitation |

### EXAMPLE III

Several other sizing compositions of the present invention were prepared. These compositions were made in a similar manner as those made in Example I. However, a different type of polypropylene emulsion, PP353C from DuPont, was used in some of the formulations. Table 4 describes the sizing compositions prepared using the PP 448C polypropylene emulsion (samples 7-15)and Table 5 describes the sizing compositions prepared using the PP353C polypropylene emulsion (samples 16-24).

TABLE 4

| | | 7 | | 8 | | 9 |
|---|---|---|---|---|---|---|
| SAMPLE | | Amount in | | Amount in | | Amount in |
| INGREDIENTS | % | grams | % | grams | % | grams |
| A1100 | 1.5 | 225 | 1.5 | 225 | 1.5 | 225 |
| Acetic Acid | | pH = 5.1 | | pH = 5.1 | | pH = 5.1 |
| PP448C emulsion | 10.0 | 1500 | 12.0 | 1800 | 12.0 | 1800 |
| Aquathene 52-00-01 | 0.5 | 75 | 0.0 | — | 0.5 | 75 |
| Moldpro 932 (26%) | 5.0 | 750 | 5.0 | 750 | 5.0 | 750 |
| Theor. Mix Solids | | 4.9% | | 5.2% | | 5.4% |
| Actual Quantity | | | | | | |
| Solids(gms) | | 14,000 | | 14,000 | | 14,000 |
| Percent Solids | | 4.96% | | 4.96% | | 5.33% |
| | | 10 | | 11 | | 12 |
| SAMPLE | | Amount in | | Amount in | | Amount in |
| INGREDIENTS | % | grams | % | grams | % | grams |
| A1100 | 1.5 | 225 | 1.5 | 225 | 1.5 | 225 |
| Acetic Acid | | pH = 5.1 | | pH = 5.1 | | pH = 5.1 |
| PP448C emulsion | 12.0 | 1800 | 12.0 | 1800 | 10.0 | 1500 |
| Aquathane 52-00-01 | 0.5 | 75 | — | — | — | — |
| Moldpro 932 (26%) | 1.0 | 150 | 1.0 | 150 | 1.0 | 150 |
| Theor. Mix Solids | | 4.36% | | 4.16% | | 3.66% |
| Actual Quantity | | | | | | |
| Solids (gms) | | 14,000 | | 14,000 | | 14,000 |
| Percent Solids | | 4.6% | | 4.4% | | 3.82% |
| | | 13 | | 14 | | 15 |
| SAMPLE | | Amount in | | Amount in | | Amount in |
| INGREDIENTS | % | grams | % | grams | % | grams |
| A1100 | 1.5 | 225 | 1.5 | 225 | 1.5 | 225 |
| Acetic Acid | | pH = 5.1 | | pH = 5.1 | | pH = 5.1 |
| PP448C emulsion | 10.0 | 1500 | 10.0 | 1500 | 11.0 | 1650 |
| Aquathane 52-00-01 | 0.5 | 75 | — | — | 0.25 | 37.5 |
| Moldpro 932 (26%) | 1.0 | 150 | 5.0 | 750 | 3.00 | 450 |
| Theor. Mix Solids | | 3.86% | | 4.7% | | 4.53% |
| Actual Quantity | | | | | | |
| Solids (gms) | | 14,000 | | 14,000 | | 14,000 gm |
| Percent Solids | | 4.06% | | 4.69% | | 4.69% |

TABLE 5

| SAMPLE | | 16 | | 17 | | 18 |
|---|---|---|---|---|---|---|
| INGREDIENTS | % | Grams | % | Grams | % | Grams |
| A1100 | 1.5 | 112 | 1.5 | 112 | 1.5 | 112 |
| Acetic Acid | | 50 | | 50 | | 50 |
| PP353C emulsion | 10.0 | 750 | 12.0 | 900 | 12.0 | 900 |
| Aquathane 52-00-01 | 0.5 | 37.5 | — | — | 0.5 | 37.5 |
| Moldpro 932 (26%) | 5.0 | 375 | 5.0 | 375 | 5.0 | 375 |
| Strand Solids | | — | | 0.98 | | 1.05 |
| Actual Quantity (gms) | | 5,000 | | 5,000 | | 5,000 |
| SAMPLE | | 19 | | 20 | | 21 |
| INGREDIENTS | % | Grams | % | Grams | % | Grams |
| A1100 | 1.5 | 112 | 1.5 | 112 | 1.5 | 112 |
| Acetic Acid | | 50 | | 50 | | 50 |
| PP353C emulsion | 12.0 | 900 | 12.0 | 900 | 10.0 | 750 |
| Aquathante 52-00-01 | 0.5 | 75 | — | — | — | — |
| Moldpro 932 (26%) | 1.0 | 75 | 1.0 | 75 | 1.0 | 75 |
| Strand Solids | | 0.70 | | 0.69 | | 0.68 |
| Actual Quantity (gms) | | 5,000 | | 5,000 | | 5,000 |
| SAMPLE | | 22 | | 23 | | 24 |
| INGREDIENTS | % | Grams | % | Grams | % | Grams |
| A1100 | 1.5 | 112 | 1.5 | 112 | 1.5 | 112 |
| Acetic Acid | | 50 | | 50 | | 50 |
| PP353C emulsion | 10.0 | 750 | 10.0 | 750 | 11.0 | 825 |
| Aquathane 52-00-01 | 0.5 | 37.5 | — | — | 0.25 | 19 |
| Moldpro 932 (26%) | 1.0 | 75 | 5.0 | 310 | 3.00 | 225 |
| Strand Solids | | 0.7 | | 0.74 | | 0.87 |
| Actual Quantity (gms) | | 5,000 | | 5,000 | | 5,000 |

### EXAMPLE IV

The sizing compositions comprising the emulsion of polypropylene PP353C as shown in Table 5 were applied to glass fibers having a diameter of 9 microns according to known methods. The physical strand properties of the sized glass fibers were assessed and the results obtained therefrom are described in Table 6. The applicator speed is recorded in feet per minute (fpm), and the strand moisture content and strand solids are recorded in percent by weight of the resulting sized strands. The amount of fines present after chopping the strands into segments was determined by mechanically sieving a given amount of chopped strands through a specified opening screen for a predetermined amount of time. The accumulated fine fibers that have passed through the sieve are then weighed and recorded as a percentage by weight of the chopped strands.

The strand integrity of the dry chopped strands provides an indication of how well the glass reinforcement will resist fuzzing during glass feeding or blending. A given amount of chopped strands is subjected to agitation for a predetermined time in the presence of steel balls using a paint shaker. The resulting material is then sieved to remove fines, weighed, and recorded as a percentage of the chopped strands.

The long fibers in the chopped strands, which are at least twice the length of the nominal chopped length, is determined by mechanically sieving a predetermined amount of chopped strands through a vibrating screen having specified openings. The strands that do not pass through the screen are collected, weighed, and recorded as a percentage of the chopped strand segments.

TABLE 6

| | | | | | | Long Fiber |
|---|---|---|---|---|---|---|
| Applicator Speed | Sample | Moisture (%) | Solids (%) | Fines (%) | 3 Min S.I. (%) | (%) |
| 54 fpm | 21 | 0 | 0.68 | 2.7 | 3.37 | 0.647 |
| 52 fpm | 17 | 0.017 | 0.98 | 2.82 | 17.07 | 2.914 |
| 52 fpm | 16 | | PLUGGED | | | |
| | | | PUMP | | | |
| 52 fpm | 23 | 0.013 | 0.74 | 3.4 | 46.63 | 1.35 |
| 52 fpm | 22 | 0 | 0.7 | 2.32 | 15.24 | 0.797 |
| 50 fpm | 24 | 0.093 | 0.87 | 4.5 | 50.9 | 1.42 |
| 48 fpm | 18 | 0.021 | 1.05 | 2.85 | 17.8 | 3.35 |
| 48 fpm | 20 | 0 | 0.69 | 2.95 | 21.76 | 0.41 |
| 48 fpm | 19 | 0.003 | 0.70 | 2.5 | 12.1 | 0.24 |

Glass fiber reinforced composites were prepared as described above in Example I using the glass fibers sized with the sizing compositions detailed above. The composites were evaluated for tensile strength according to ASTM D638 and impact strength according to ASTM D790, and the results obtained are provided in Table 7.

TABLE 7

| Sample | Tensile (psi) | Unnotched IZOD (ft-.lb/in) | Glass Content % |
|---|---|---|---|
| 16 | 12,587 | 12.851 | 30 |
| 21 | 11,091 | 11.36 | 30.2 |
| 17 | 11,864 | 12.719 | 30 |
| 23 | 11,177 | 11.842 | 30.1 |
| 22 | 10,983 | 11.316 | 30.1 |
| 24 | 10,857 | 11.272 | 30.1 |
| 18 | 11,552 | 12.149 | 30.1 |
| 20 | 11,058 | 11.754 | 29.9 |
| 19 | 10,862 | 11.711 | 29.9 |

### EXAMPLE V

Another set of experiments were conducted to confirm the effect of the cationic lubricant addition to the polypropylene sizing chemistry. This comparative experiment examined the effects of two different polypropylene emulsions with and without the cationic lubricant. Sizing compositions (samples 25-31) were prepared in accordance with the formulations provided in Table 8 and by the methods similar to those used to prepare the compositions in Example I.

TABLE 8

| Sample | 25 | | 26 | | 27 | | 28 | | 29 | | 30 | | 31 | |
|---|---|---|---|---|---|---|---|---|---|---|---|---|---|---|
| Ingredient | % | gms | % | Gms | % | Gms | % | gms | % | gms | % | gms | % | gms |
| A1100 | 1.5 | 150 | 1.50 | 150 | 1.5 | 150 | 1.5 | 150 | 1.5 | 150 | 1.50 | 150 | 1.5 | 150 |
| TA22⁷ | 225 | 225 | 2.25 | 225 | 2.25 | 225 | 2.25 | 225 | 225 | 225 | 2.25 | 225 | 2.25 | 225 |
| NH₄oH | 1.4 | 140 | 1.4 | 140 | 14 | 140 | 1.4 | 140 | 1.4 | 140 | 1.4 | 140 | 1.4 | 140 |
| PP448C | 11.0 | 1,100 | 11.0 | 1,100 | | | | | 11.0 | 1,100 | | | | |
| PP353C | | | | | 11.0 | 1,100 | 11.0 | 1,100 | | | 11.0 | 1,100 | 11.0 | 1,100 |
| Aquathane | 0.5 | 50 | 0.5 | 50 | 0.5 | 50 | 0.5 | 50 | 0.5 | 50 | 0.5 | 50 | 0.5 | 50 |
| 52-00-01 | | | | | | | | | | | | | | |
| K-12 (8.8%) | 0.24 | 24 | | | 0.24 | 24 | | | 0.24 | 24 | | | 0.24 | 24 |
| 6760 (50%) | | | 0.05 | 5 | | | 0.05 | 5 | | | | | 0.05 | 5 |
| Acetic Acid | | | | | | | | | | | | | 1.0 | 100 |
| Quantity Solids | | 10,000 | | 10,000 | | 10,000 | | 10,000 | | 10,000 | | 10,000 | | 10,000 |

⁷TA22 is terephthalic acid commercially available from Amoco.

Glass fibers having a diameter of 13.7 and 17 microns, respectively, were coated with the sizing compositions of samples 25-31 according to known methods, and the physical strand properties of the sized glass fibers were determined as described above in Example IV. The average values are set forth in Table 9.

TABLE 9

| SAMPLE I.D. | MOIST | SOLIDS | 3 MIN S.I. |
|---|---|---|---|
| 25 | 0.023 | 0.77 | 0.98 |
| 26 | 0.029 | 0.75 | 0.84 |
| 27 | 0.030 | 0.77 | 0.06 |
| 28 | 0.026 | 0.81 | 0.01 |
| 29 | 0.023 | 0.65 | 1.12 |
| 30 | 0.020 | 0.64 | 0.54 |

Based on these results, the inclusion of the cationic lubricant appears to increase the amount of the sizing composition picked up by the fibers from the applicator.

Glass fiber reinforced composites formed from chopped glass fibers sized with the sizing compositions detailed above and a polypropylene resin according to the method described above in Example I were assessed for tensile and impact strengths. The composite properties were determined and are provided in Table 10.

TABLE 10

| | | | Glass |
|---|---|---|---|
| Sample | Tensile St (psi) | Unnotched IZOD (ft-lb/in) | Content (%) |
| 25 | 12,175 | 12.149 | 29.8 |
| 26 | 12,183 | 12.965 | 29.8 |
| 27 | 12,325 | 13.193 | 30 |
| 28 | 12,297 | 12.412 | 30 |
| 29 | 12,196 | 12.956 | 30 |
| 30 | 12,276 | 12.544 | 29.8 |

These results demonstrate the effect of the sizing compositions of this invention on the resulting composites. As can be readily ascertained, the sizing compositions of the invention provide excellent results when used in the reinforcement of polypropylene matrices.

### EXAMPLE VI

Another set of sizing compositions were prepared and used to size glass fibers having a diameter of 13.7 microns according to known methods. The sizing compositions and the resulting solids content are provided in Table 11.

TABLE 11

| SAMPLE | 32 | | 33 | | 34 | | 35 | | 36 | | 37 | |
|---|---|---|---|---|---|---|---|---|---|---|---|---|
| INGREDIENTS | % | gms | % | gms | % | gms | % | gms | % | gms | % | gms |
| A1100 | 1.83 | 183 | 1.16 | 116 | 1.5 | 150 | 1.16 | 116 | 1.16 | 116 | 1.83 | 183 |
| PP353C | 14.66 | 1,466 | 9.36 | 936 | 12.0 | 1200 | 9.36 | 936 | 9.36 | 936 | 14.66 | 1,466 |
| Aquathane 52-00-01 | 0.61 | 61 | 0.39 | 39 | 0.5 | 50 | 0.39 | 39 | 0.39 | 39 | 0.61 | 61 |
| K-12 (8.8%) | 0.29 | 29 | 0.19 | 19 | 0.24 | 24 | 0.24 | 24 | | | | |
| Moldpro 932 | 3.67 | 367 | 2.34 | 234 | 3.0 | 300 | 2.34 | 234 | 2.34 | 234 | 3.67 | 367 |
| Acetic Acid | | | | pH 7.0 | | pH 8.5 | | | | | | pH 7.0 |
| Quantity Solids (gms) | | 10,000 | | 10,000 | | 10,000 | | 10,000 | | 10,000 | | 10,000 |
| Percent Solids (%) | | 5.73 | | 3.67 | | 4.72 | | 3.68 | | 3.71 | | 5.76 |
| pH | | 6.8 | | 8.7 | | 6.7 | | 9.5 | | 7.6 | | 6.4 |

| SAMPLE | 38 | | 39 | | 40 | | 41 | | 42 | |
|---|---|---|---|---|---|---|---|---|---|---|
| INGREDIENTS | % | gms | % | gms | % | gms | % | gms | % | gms |
| A1100 | 1.83 | 183 | 1.16 | 116 | 1.83 | 183 | 1.5 | 150 | 1.5 | 150 |
| PP353C | 14.66 | 1,466 | 9.36 | 936 | 14.66 | 1,466 | | | 12.0 | 1,200 |
| Aquathane | 0.61 | 61 | 0.39 | 39 | 0.61 | 61 | 0.5 | 50 | 0.5 | 50 |
| 52-00-01 | | | | | | | | | | |
| K-12 (8.8%) | 0.29 | 29 | 0.24 | 24 | 0.29 | 29 | 0.24 | 24 | 0.24 | 24 |
| Moldpro 932 | 3.67 | 367 | 2.34 | 234 | 3.67 | 367 | 3.0 | 300 | 3.0 | 300 |
| Acetic Acid | | pH 7.0 | | pH 7.0 | | | 12.0 | 1,200 | | |
| Quantity Solids | | 10,000 | | 10,000 | | 10,000 | | 10,000 | | 10,000 |
| (gms) | | | | | | | | | | |
| Percent Solids | | 5.84 | | 3.76 | | 5.86 | | 4.86 | | |
| (%) | | | | | | | | | | |
| pH | | 6.4 | | 6.5 | | 6.6 | | 10.3 | | |

In the method of preparing these compositions, it was noted that when the PP353C polypropylene emulsion was added to the A1100 premix, the mixture tended to precipitate. Therefore, the pH was adjusted to near neutral with acetic acid in order to stabilize the mixture. The addition of the PP448C polypropylene emulsion to the A1100 premix, on the other hand, was stable.

In addition, it was noted that the stability of the sizing with compositions containing the 353C polypropylene emulsion was even more stable when the A1100 premix was diluted with water at a ratio of 10 parts of water to 1 part A1100.

### EXAMPLE VII

The sizing compositions of Samples 32-41 were used to size glass fibers having a diameter of 13.7 microns according to known methods. The moisture, solids content, and strand integrity of the sized fiber strands were determined as detailed above in Example IV, and are set forth in Table 12.

TABLE 12

| SAMPLE | MOIST (%) | SOLIDS (%) | 3 MIN. S.I. (%) |
|---|---|---|---|
| 32 | 0.032 | 0.67 | 0.15 |
| 33 | 0.022 | 0.46 | 1.89 |
| 34 | 0.027 | 0.49 | 0.06 |
| 35 | 0.016 | 0.40 | 4.36 |
| 36 | 0.009 | 0.40 | 4.05 |
| 37 | 0.018 | 0.71 | 0.83 |
| 38 | 0.023 | 0.74 | 0.58 |
| 39 | 0.012 | 0.44 | 6.56 |
| 40 | 0.009 | 0.71 | 0.61 |
| 41 | 0.015 | 0.49 | 0.49 |

The sized fibers were then used to prepare composites according to the methods described above in Example I. The properties of the resulting composites prepared from these sized fibers are provided in Table 13.

TABLE 13

| | | Unnotched IZOD | Glass | Strand |
|---|---|---|---|---|
| Sample | Tensile St (psi) | (ft-lb/in) | Content (%) | Solid (%) |
| 32 | 12,800 | 13.333 | 30.2 | 0.67 |
| 33 | 12,744 | 13.026 | 30.1 | 0.46 |
| 34 | 12,720 | 13.772 | 30.3 | 0.49 |
| 35 | 12,448 | 13.553 | 30.1 | 0.4 |
| 36 | 12,316 | 13.465 | 29.9 | 0.4 |
| 37 | 12,273 | 13.772 | 30.1 | 0.71 |
| 38 | 12,479 | 13.772 | 29.8 | 0.74 |
| 39 | 12,518 | 13.289 | 30.3 | 0.44 |
| 40 | 12,422 | 13.772 | 29.9 | 0.71 |
| 41 | 12.053 | 13.947 | 30.6 | 0.49 |

Furthermore, the composites formed with the fibers sized with the compositions of samples 32-41 were tested for tensile fatigue according to the procedures of ASTM D-2991. The results of this analysis are set forth in Table 14, in terms of the average number of cycles until failure occurred at 8.4 Kpsi.

TABLE 14

| Sample | Tensile Fatigue at 8.4 Kpsi |
|---|---|
| 32 | 1,384 |
| 33 | 1,500 |
| 34 | 1,428 |
| 35 | 1,438 |
| 38 | 1,589 |
| 37 | 1,998 |
| 38 | 1,808 |
| 39 | 1,787 |
| 40 | 1,576 |
| 41 | 1,489 |

Based on these results, it appears that the best tensile fatigue results were obtained with the composite formed of fibers sized with the composition of Sample 37.

### EXAMPLE VIII

Four sizing compositions (samples 43-46) were prepared according to the method of Example I having the formulations described in Table 15.

TABLE 15

| Ingredients | % | 43 | % | 44 | % | 45 | % | 46 |
|---|---|---|---|---|---|---|---|---|
| A1100 | 1.5 | 210 | 1.5 | 165 | 1.5 | 165 | 1.5 | 165 |
| TA22 | 2.25 | 315 | 2.25 | 247 | | | | |
| NH₄oH | 1.4 | 200 | 1.4 | 154 | | | | |
| MB4000M⁸ | 12.0 | 1680 | | | | | | |
| Aquathane 52-00-01 | 0.5 | 70 | 0.5 | 55 | 0.5 | 55 | | |
| Moldpro 932 | 2.25 | 315 | 2.25 | 247 | 3.0 | 330 | 3.0 | 330 |
| PP448C | | | 12.0 | 1320 | 11.0 | 1200 | | |
| PP353C | | | | | | | 120 | 1320 |
| Quantity Solids (gms) | | 14,000 | | 11,000 | | 11,000 | | 11,000 |

These sizing compositions were used to size glass fibers and the physical strand properties were assessed as described in Example IV. The results are shown below in Table 16.

TABLE 16

| Sample | St. solids (%) | Fines (%) | St. integrity (%) |
|---|---|---|---|
| 43 | 0.97 | 3.3 | 7.3 |
| 44 | 0.9 | 4.8 | 4.3 |
| 45 | 0.69 | 3.9 | 4.9 |
| 46 | 0.61 | 4.7 | 15.3 |

The sized strands were chopped and formed into polypropylene composites according to the method discussed above in Example I. The composite properties were assessed and are provided in Table 17.

TABLE 17

| | | | | Notched | Unnotched | Glass |
|---|---|---|---|---|---|---|
| | Tensile | Flexural | Flexural | IZOD | IZOD | Content |
| Sample | St (psi) | St (psi) | Mod. (ksi) | (ft-lb/in) | (ft-lb/in) | (%) |
| 43 | 12,153 | 18,171 | 691 | 2.167 | 11.833 | 30.2 |
| 44 | 12,147 | 18,328 | 691 | 2.114 | 12.465 | 30.4 |
| 45 | 12,372 | 17,970 | 649 | 2.342 | 13.044 | 29.8 |
| 46 | 11,657 | 18,571 | 700 | 2.272 | 13.325 | 29.6 |

The foregoing Examples are provided for purposes of illustrating the sizing composition of the invention, and are not intended to limit the scope of the invention as defined by the claims which follow.

We claim:

1. A sizing composition for application to glass reinforcing fibers comprising: a maleic acid or anhydride modified polypropylene film former having a molecular weight in excess of 35,000 Daltons, an aminosilane coupling agent, a cationic lubricant, and a fatty acid nucleating agent having from 10 to 18 carbon atoms.

2. The composition of claim 1, wherein said modified polypropylene film former comprises polypropylene grafted with maleic anhydride.

3. The composition of claim 2, wherein said modified polypropylene film former has a molecular weight in excess of about 80,000.

4. The composition of claim 2, wherein said cationic modified polypropylene film former is present in an amount of from about 40 to about 80 weight percent of the total dried sizing; said aminosilane is present in an amount of from about 10 to about 20 weight percent of the total dried sizing; said cationic lubricant is present in an amount of from about 0.25 to about 1.3 weight percent of the total dried sizing; and said nucleating agent is present in an amount of from about 8 to about 15 weight percent of the total dried sizing.

5. The composition of claim 2, wherein said aminosilane is a mono- or di-aminated aminosilane.

6. The composition of claim 5, wherein said aminosilane is gamma-aminopropyltriethoxysilane.

7. The composition of claim 2, wherein said cationic lubricant is selected from the group consisting of ethoxylated amines.

8. The composition of claim 7, wherein said cationic lubricant is polyethyleneinine polyamide.

9. The composition of claim 2, wherein said nucleating agent is selected from the group consisting of terephthalic acid, sebasic acid, stearic acid, palmitic acid, and mixtures thereof.

10. The composition of claim 9, wherein said nucleating agent is terephthalic acid.

11. The composition of claim 2, wherein said aminosilane is a mono- or di-aminated aminosilane, said cationic lubricant is an ethoxylated amine and said nucleating agent is selected from the group consisting of terephthalic acid, sebasic acid, stearic acid, palmitic acid and mixtures thereof.

12. Glass fibers for reinforcing polymeric materials comprising, glass fibers coated with the dried residue of a sizing composition comprising: a maleic acid or anhydride modified polypropylene film former having a molecular weight in excess of about 35,000, an amino silane coupling agent, a cationic lubricant, and a fatty acid nucleating agent having 10 to 18 carbon atoms.

13. The glass fibers of claim 12, wherein said cationic polypropylene film former comprises polypropylene grafted with maleic anhydride.

14. The glass fibers of claim 13, wherein said modified polypropylene film former has a molecular weight in excess of about 80,000.

15. The glass fibers of claim 13, wherein, said cationic polypropylene film former is present in an amount of from about 40 to about 80 weight percent of the total dried sizing; said amino silane is present in an amount of from about 10 to about 20 weight percent of the total dried sizing; said cationic lubricant is present in an amount of from about 0.25 to about 1.3 weight percent of the total dried sizing; and said nucleating agent is present in an amount of from about 8 to about 15 weight percent of the total dried sizing.

16. The glass fibers of claim 13, wherein said aminosilane is a mono- or di-aminated aminosilane.

17. The glass fibers of claim 16, wherein said aminosilane is gamma-aminopropyltriethoxysilane.

18. The glass fibers of claim 13, wherein said cationic lubricant is selected from the group consisting of ethoxylated amines.

19. The glass fibers of claim 18, wherein said cationic lubricant is polyethyleneimine polyamide.

20. The glass fibers of claim 13, wherein said nucleating agent is selected from the group consisting of terephthalic acid, sebasic acid, stearic acid, palmitic acid and mixtures thereof.

21. The glass fibers of claim 20, wherein said nucleating agent is terephthalic acid.

22. The glass fibers of claim 13 wherein said aminosilane is a mono- or di-aminated aminosilane, said cationic lubricant is an ethoxylated amine and said nucleating agent is selected from the group consisting of terephthalic acid, sebasic acid, stearic acid, palmitic acid and mixtures thereof.

23. A polypropylene matrix reinforced by glass fibers defined in claim 13.

24. A method for improving tensile creep and tensile fatigue in polypropylene matrix composites reinforced with glass fibers comprising treating said glass fibers with the sizing composition of claim 1 prior to their introduction into said polypropylene matrix material.
